(19) United States
(12) Patent Application Publication
(10) Pub. No.: US 2021/0222913 A1
(43) Pub. Date: Jul. 22, 2021

(54) SYSTEM AND METHOD FOR PROVIDING MAKE UP COMBUSTION AIR AND CARBON DIOXIDE DETECTION FOR AN ATMOSPHERIC COMBUSTION APPLIANCE

(71) Applicant: Stephen Huggins, Middleton, MA (US)

(72) Inventor: Stephen Huggins, Middleton, MA (US)

(21) Appl. No.: 16/747,865

(22) Filed: Jan. 21, 2020

(51) Int. Cl. F24H 9/20; F24H 1/28

(52) U.S. Cl. CPC F24H 9/2035; F24D 19/1015; F24H 1/28

(57) ABSTRACT

A system for controlling a combustion appliance based on one or more localized environmental factors and an inlet/exhaust system enclosed within a single enclosure. The control system includes an electrically controlled fuel valve, coupled to a source of combustion appliance fuel, and responsive to a fuel valve control signal, for controlling the flow of fuel to the appliance. An air pressure detector is disposed in an area proximate the combustion appliance and configured for detecting negative air pressure in the proximate area and in response for providing a negative air pressure detection signal to a relay which will deactivate the fuel valve until negative air pressure is not present thereby preventing operation of the combustion appliance. Further, if negative air pressure is detected, the relay energizers a makeup air device to bring an outside air into the area near the combustion appliance.

### TECHNICAL FIELD

The present invention relates to atmospheric combustion appliances and issues with combustion or exhaust air for the appliance and more particularly, relates to a system and method for providing make up combustion air and/or exhaust air for the area in and around gas combustion appliances.

### BACKGROUND INFORMATION

An atmospheric combustion appliance is one that draws air from the space around the appliance. An example of such appliances are heating systems and hot water heaters operating on gas or oil for example. These appliances work by pulling air from the room in which these appliances are located to mix with the gas be provided to the appliance so that the appliance may burn the mixture of gas an air. Combustion gases are exhausted to the outside through a flue.

When the atmospheric combustion appliance is running, it is pulling room air and using that air to blend with the appliance fuel to create heat, and sending combustion air to the outside through the appliances vent flue. Houses and buildings are more energy efficient and air tight today than ever. This is beneficial in terms of heating costs, but it can cause problems f you don't allow your home to “breathe.” Negative air pressure is one such problem. For negative air pressure to occur, the air pressure inside a building or home must be lower than the pressure outside. This typically happens when more air is leaving the interior of the home than being replenished from the outside. The difference in pressure causes air to be sucked in through any number of undesirable passages. This negative pressure can result in increased energy bills because the conditioned space is constantly being cooled by the infiltrating outside air. In addition, in some instances, the conditioned space may become so cold that water pipes may freeze.

Negative pressurization is a huge ventilation problem plaguing residential buildings in the United States. Air often travels through crawl spaces, attics, basements, and other filthy spaces before reaching living areas which leads to diminished indoor air quality. There are many adverse health effects related to poor indoor air quality. In addition, air pulled in through cracks in basement floor brings in heavier than air gases, such as radon. Radon poisoning can damage lungs and cause lung cancer.

Lastly and most importantly, if a home or building is suffering the effects of negative air pressure, both air and possibly deadly gases are being sucked back into the home or building. Backdrafting of carbon monoxide expelled from fuel-fired appliances such as furnaces, water heaters, and boilers can result in carbon monoxide poisoning or death.

Several prior art methods at reducing or eliminating negative pressure near the atmospheric combustion appliance involves providing a constant opening to the outside. This provides makeup air and eliminates negative pressure however, the makeup air, particularly in the cold or winter months, significantly cools the space around the atmospheric combustion appliance resulting in cold, drafty and potentially freezing conditions in the space around the appliance.

An additional problem caused by the negative pressure from operating atmospheric combustion appliances in spaces or areas without sufficient makeup air is the possibility that the atmospheric combustion appliance may back draft causing combustion gases including dangerous and potentially deadly carbon-dioxide gas to be drawn into the space in which the atmospheric combustion appliance is operating.

Accordingly, what is needed is a system and method to first of all detect negative pressure in the area around an atmospheric combustion appliance and if and only if this condition is detected, to provide an opening to a source of makeup combustion air while the negative pressure condition exists, while closing the opening to the outside makeup air when the negative pressure does not exist.

What is also needed is a system and method to detect the presence of increased levels of carbon dioxide in the space in and around the atmospheric combustion appliance and to energize an exhaust fan and exhaust path for carbon dioxide laden gases to the outside while at the same time cutting off power/fuel to the combustion appliance to be sure that no further carbon dioxide laden gases will be generated and exhausted into the space around the appliance.

What is also needed is an air inlet and exhaust device, contained in a single enclosure, for controlling inlet and exhaust air to and from an area proximate a combustion appliance.

### SUMMARY

The present invention features a system for controlling a combustion appliance based on one or more localized environmental factors. The system includes an electrically controlled gas valve, coupled to a source of gas and to a combustion appliance, and responsive to a gas valve control signal, and configured in a first operative mode in response to the gas valve control signal, for providing an uninterrupted flow of gas to the combustion appliance. The electrically controlled gas valve is configured in a second operative mode and responsive to the absence of the gas valve control signal, for interrupting the flow of gas from the source of gas to the combustion appliance.

The system also includes a temperature controlled combustion appliance activation device, configured, in a first operative mode, for providing a combustion appliance activation signal, and in a second operative mode, for causing an absence of the combustion appliance activation signal. An air pressure detector is provided. The air pressure detector is disposed in an area proximate the combustion appliance and configured for detecting negative air pressure in the area proximate the air pressure detector and the combustion appliance, and responsive to the detecting negative air pressure, for providing a negative air pressure detection signal.

A relay is coupled to the temperature controlled combustion appliance activation device, the air pressure detector, the gas valve and to a makeup air device, and responsive to the presence or absence of the combustion appliance activation signal from the temperature controlled combustion appliance activation device and to the presence or absence of the negative air pressure detection signal from the air pressure detector, for providing, in a first operative mode and in response to the presence of the combustion appliance activation signal and the absence of the negative air pressure detection signal, the gas valve control signal and for, in a second operative mode and responsive to the presence of the combustion appliance activation signal and the presence of the negative air pressure detection signal, for not providing the gas valve control signal causing the absence of the gas valve control signal, and for providing, in the second operative mode, a makeup air device activation signal.

A makeup air device is disposed in the area proximate the combustion appliance and the air pressure detector and is coupled to a source of makeup air, and responsive to a makeup air device activation signal, for selectively providing makeup air to the area proximate the combustion appliance.

In one embodiment, the temperature controlled combustion appliance activation device is disposed on the combustion appliance or remote from the combustion appliance. The temperature controlled combustion appliance activation device may be a thermostat. In another embodiment, the source of makeup air includes outside air. The makeup air device may include an electrically controllable fan/blower.

In another embodiment, the system may further include a carbon monoxide detector, disposed in an area proximate the combustion appliance and configured for detecting carbon monoxide in the area proximate the carbon monoxide detector and the combustion appliance, and responsive to the detecting carbon monoxide, for providing a carbon monoxide detection signal. In this embodiment, the relay is coupled to the carbon monoxide detector and responsive to the presence or absence of the carbon monoxide detection signal, and wherein in the second operative mode, the relay is responsive to the presence of the carbon monoxide detection signal, for not providing the gas valve control signal causing the absence of the gas valve control signal.

In the second embodiment, the system further includes an air exhaust device, disposed in the area proximate the combustion appliance and coupled to an area remote from the area proximate the combustion appliance, and responsive to the carbon monoxide detection signal, for moving air from the area proximate the carbon monoxide detector and the combustion appliance to an area remote from the area proximate the carbon monoxide detector and the combustion appliance. The area remote from the area proximate the carbon monoxide detector and the combustion appliance may include an area outside of an enclosed building.

In one embodiment, the air exhaust device and the makeup air device are operable in one enclosure including one fan and a plurality of louvers operated by one or more louver or damper motor(s), wherein one of the plurality of louvers is operative in the first mode and in response to the negative air pressure detection signal, for providing outside air to the area proximate the combustion appliance, wherein a second one of the plurality of louvers is operative and a second mode in response to the carbon monoxide detection signal, for removing air from the area proximate the combustion appliance to an area remote from the area proximate the combustion appliance.

In each embodiment, the combustion appliance is a heating appliance which may be selected from the group of heating appliances consisting of a hot water heater and furnace.

It is important to note that the present invention is not intended to be limited to a device or method which must satisfy one or more of any stated or implied objects or features of the invention. It is also important to note that the present invention is not limited to the preferred, exemplary, or primary embodiment(s) described herein.

Modifications and substitutions by one of ordinary skill in the art are considered to be within the scope of the present invention, which is not to be limited except by the allowed claims and their legal equivalents.

### BRIEF DESCRIPTION OF THE DRAWINGS

These and other features and advantages of the present invention will be better understood by reading the following detailed description, taken together with the drawings wherein:

FIG. 1 is a block diagram of a system for controlling a combustion appliance based on one or more localized environmental factors;

FIGS. 2A and 2B are schematic diagrams of damper motor and damper blade assemblies along with appropriate linkage according to one feature of the present invention;

FIG. 3A is a schematic diagram of the fan assembly according to one aspect of the present invention shown configured to provide makeup air based on negative air pressure; and

FIG. 3B is a schematic diagram of the fan assembly according to one aspect of the present invention shown configured to provide exhaust air.

### DETAILED DESCRIPTION OF THE PREFERRED EMBODIMENTS

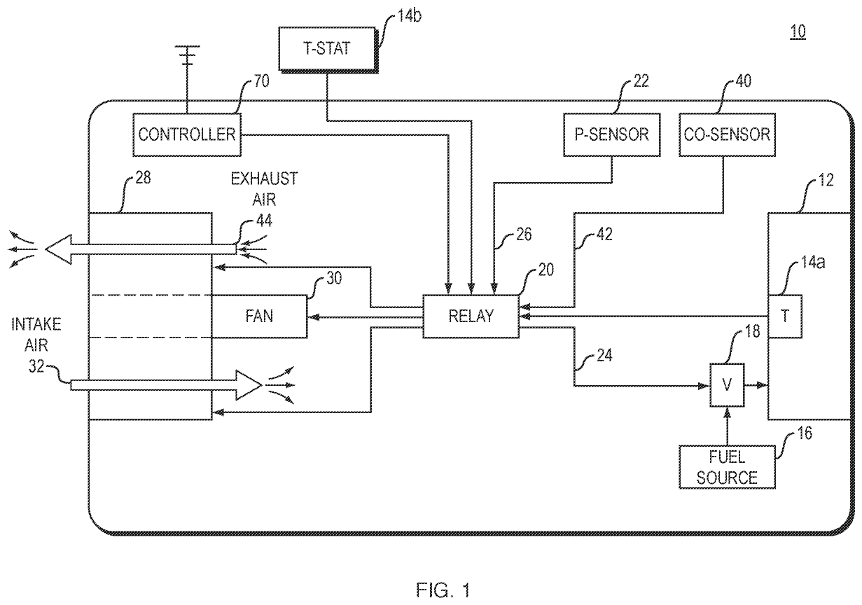

The present invention discloses a system 10, FIG. 1, for controlling an atmospheric combustion appliance 12, such as, for example, a gas combustion appliance typically located in the basement of a home or other building or a more confined mechanical room of such home or building. Examples of such appliances include, without limitation, furnaces and hot water heaters. The present invention will be explained in connection with gas combustion appliances but this is not a limitation of the present invention as appliances operated by other fuel sources such as oil are contemplated and considered to be within the scope of the present invention.

The combustion appliance 12 is activated by a thermostat 14 located either directly on the appliance 12 itself or more typically remotely such as in a heated space or room within the home or building. The combustion appliance 12 is connected to a source of fuel 16 such as a source of gas or oil through a valve 18 which can be controlled to selectively activate or deactivate the appliance 12 typically, in the prior art, based solely on demand by a thermostat 14.

In accordance with the first embodiment of the present invention, the system 10 includes a relay 20 which is coupled to the thermostat 14 and, in the first embodiment, to a pressure sensor 22 located in close proximity to the combustion appliance 10. The relay 20 provides a normally closed signal 24 to the appliance fuel valve 18 which can be interrupted to ensure that the appliance 12 will not be able to operate as will be explained in greater below.

As discussed above, negative air pressure occurs when the air pressure inside a building or home is lower than the air pressure outside. This typically happens when more air is leaving the interior of the home or building than is being replenished from the outside. The difference in pressure causes air to be sucked in through any number of undesirable passages.

The present invention addresses this problem by utilizing a pressure sensor 22 located in the same room or in generally the same area as the combustion appliance 12 to detect or sense a negative pressure condition in and around the combustion appliance 12. In response to the pressure sensor 22 sensing a negative pressure condition, the pressure sensor provides a negative pressure detection signal 26 to the relay 20. As long as the negative air pressure detection signal 26 is active, if the thermostat 14 calls for the combustion appliance 12 to start or activate, the relay 20 will prevent or deactivate the combustion appliance activation signal 24 provided to the valve 18 thus disabling the combustion appliance 12.

In addition, the pressure sensor 22 will activate fan unit 28 which energizers the fan 30 to provide combustion appliance intake air 32 from the outside, thus eventually curing the negative air pressure condition. Once this occurs, the pressure sensor 22 will remove or de-energize the negative air pressure detection signal 26 allowing normal control of the appliance 12 by thermostat 14.

Accordingly, with the system of the present invention, there does not have to be a dedicated opening to outside air that is constantly open, thus creating problems with cold air inside the building or mechanical room where the combustion appliance 12 is located but rather, only when the pressure sensor 22 detects a negative air pressure in or around the combustion appliance 12 does the system of the present invention energize fan unit 28 to bring in outside air.

In yet another embodiment, the system 10 may include a carbon monoxide sensor 40 which is typically located proximate the combustion appliance 12. The carbon monoxide sensor 40 is also coupled to the relay 20. Much like the pressure sensor 22, if the carbon monoxide sensor 40 senses an increased level of carbon monoxide in and around the sensor 40, a signal 42 is provided to the relay 20 which, in turn, will de-energize fuel valve 18 turning off the combustion appliance 12 and preventing the appliance 12 from generating further carbon monoxide gas. In addition, the relay will energize fan unit 28 in such a way as to cause carbon monoxide laden air 44 to be pushed or vented outside of the room or home/building in which is located the combustion appliance 12, thus very quickly venting deadly carbon monoxide gas from the home or building.

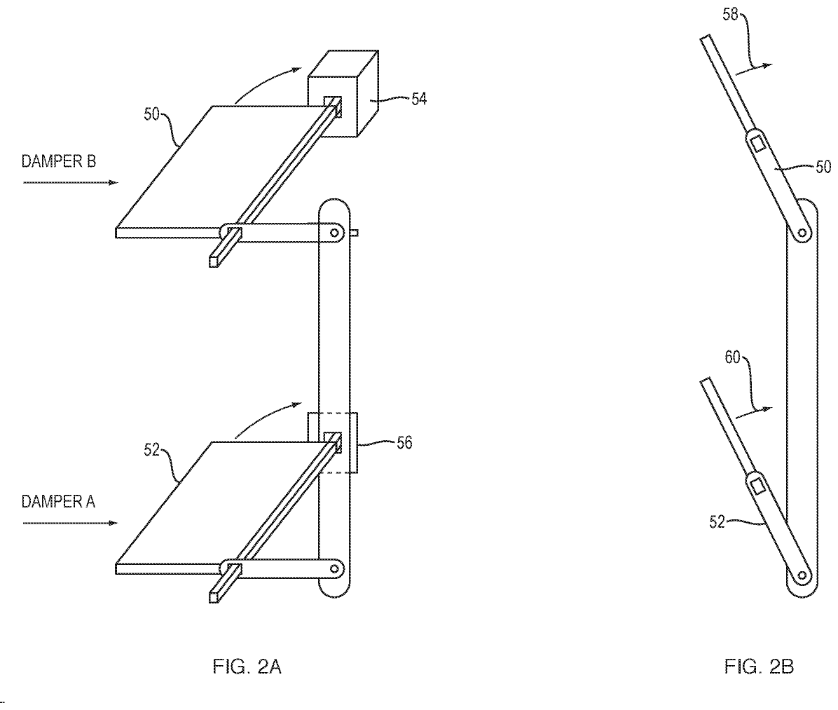

In this embodiment, the fan unit 28 may include one or more of louvers or dampers 50, 52, FIG. 2A, controlled by one or more damper motors 54, 56 which causes the louvers 50, 52 to move or pivot as shown generally by arrow's 58 and 60 in FIG. 2B.

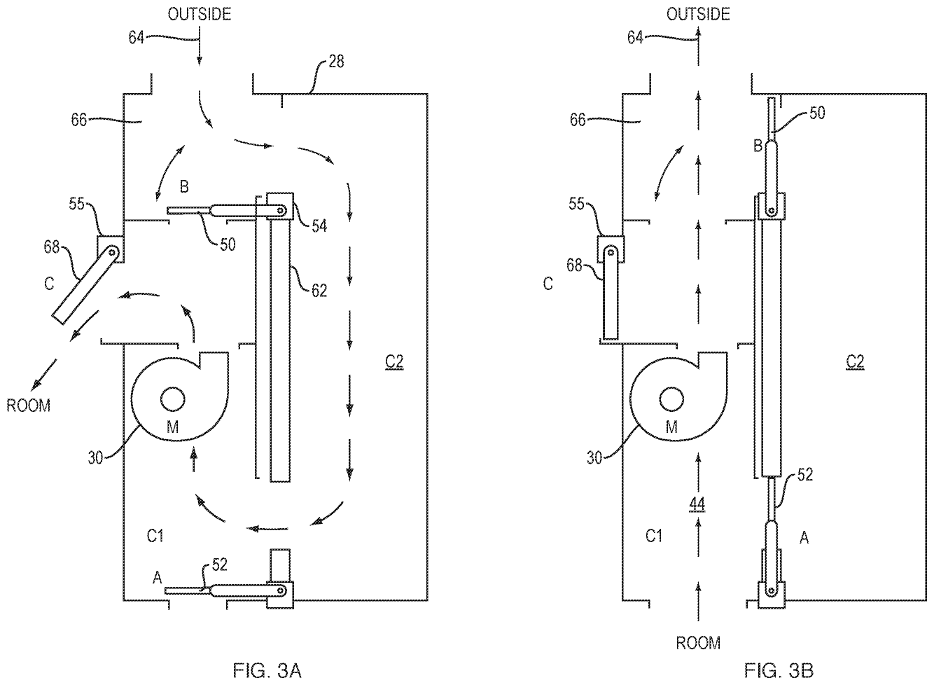

The fan unit 28 and internal louvers provided in one embodiment are shown in greater detail in FIGS. 3A and 3B. As shown in FIG. 3A which is configured to provide makeup air when negative pressure is detected, louvers A (52) and B (50) which pivot about the same structure 62 are positioned such that makeup air from the outside 64 flows into the first chamber 66 whose first exit is blocked by the position of louver B 50 and flows through chamber C2 into chamber C1 which opening is created by louver A 52 and out to the room as shown by the dashed line path created by louver C 68 which air is moved by fan 30.

In the case were carbon monoxide is detected, louvers A and B 52, 50 are positioned as shown in FIG. 3B closing off chamber C2 to but opening an air path to the room by the position of louver A, 52. By closing louver C 68 using a damper control motor 55 for example, a direct air path forced by fan 30 exhausts the carbon monoxide laden air from the room to the outside. The position of the louvers is controlled by the relay 20 which control damper or louver motors 54, 55 and 56 and the determination as to whether it is a negative pressure condition sensed by sensor 22 or a carbon monoxide sensor condition sense by sensor 40.

In another embodiment of the invention, a controller which is preferably wireless and coupled to a cell phone receiver may be utilized to monitor the condition of relay 20 and the sensors 22 and 40 and generally control the operation of the combustion appliance 12 or the fan unit 28 utilizing a remote application (APP) such as may be run on a cell phone or the like.

It is important to note that all necessary wiring and/or additional controls/relays required to implement the present invention are well within the scope of someone skilled in the art and are not presented for the sake of clarity in the accompanying drawings.

Accordingly, the present invention provides a system which can detect one or more environmental conditions such as negative air pressure or excess carbon monoxide buildup in or near a combustion appliance and in response to that detection, deactivate the combustion appliance and energize a device to either provide makeup air to alleviate a negative pressure condition proximate the combustion appliance or alternatively, to vent the air from a room or building proximate the combustion appliance and that contains an excessive amount of carbon monoxide to the outside.

It is important to note that the present invention is not intended to be limited to a device or method which must satisfy one or more of any stated or implied objects or features of the invention. Other sensors or different types of sensors may be provided, for example, to monitor different types of conditions in or near the combustion appliance. It is also important to note that the present invention is not limited to the preferred, exemplary, or primary embodiment(s) described herein.

Modifications and substitutions by one of ordinary skill in the art are considered to be within the scope of the present invention, which is not to be limited except by the allowed claims and their legal equivalents.

The invention claimed is:

1. A system for controlling a combustion appliance based on one or more localized environmental factors, said system comprising:
an electrically controlled gas valve, coupled to a source of gas and to a combustion appliance, and responsive to a gas valve control signal, configured in a first operative mode and responsive to said gas valve control signal, for providing an uninterrupted flow of gas to said combustion appliance, and configured in a second operative mode and responsive to an absence of said gas valve control signal, for interrupting said flow of gas from said source of gas to said combustion appliance;
a temperature controlled combustion appliance activation device, configured, in a first operative mode, for providing a combustion appliance activation signal, and in a second operative mode, for causing an absence of said combustion appliance activation signal;
an air pressure detector, disposed in an area proximate said combustion appliance and configured for detecting negative air pressure in said area proximate said air pressure detector and said combustion appliance, and responsive to said detecting negative air pressure, for providing a negative air pressure detection signal;
a relay, coupled to said temperature controlled combustion appliance activation device, said air pressure detector, said gas valve and to a makeup air device, and responsive to the presence or absence of said combustion appliance activation signal from said temperature controlled combustion appliance activation device and to the presence or absence of said negative air pressure detection signal from said air pressure detector, for providing, in a first operative mode and in response to the presence of said combustion appliance activation signal and the absence of said negative air pressure detection signal, said gas valve control signal and for, in a second operative mode responsive to the presence of said combustion appliance activation signal and the presence of said negative air pressure detection signal, for not providing said gas valve control signal causing said absence of said gas valve control signal, and for providing, in said second operative mode, a makeup air device activation signal; and
a makeup air device, disposed in said area proximate said combustion appliance and said air pressure detector, coupled to a source of makeup air, and responsive to a makeup air device activation signal, for selectively providing makeup air to said area proximate said combustion appliance.

2. The system of claim 1, wherein said temperature controlled combustion appliance activation device is disposed on said combustion appliance.

3. The system of claim 2, wherein said temperature controlled combustion appliance activation device is a thermostat.

4. The system of claim 1, wherein said temperature controlled combustion appliance activation device is disposed remote from said combustion appliance and outside said area proximate said combustion appliance.

5. The system of claim 4, wherein said temperature controlled combustion appliance activation device is a thermostat.

6. The system of claim 1, wherein said source of makeup air includes outside air.

7. The system of claim 6, wherein said makeup air device includes an electrically controllable fan/blower.

8. The system of claim 2, further including:
a carbon monoxide detector, disposed in an area proximate said combustion appliance and configured for detecting carbon monoxide in said area proximate said carbon monoxide detector and said combustion appliance, and responsive to said detecting carbon monoxide, for providing a carbon monoxide detection signal;
wherein said relay is coupled to said carbon monoxide detector and responsive to the presence or absence of said carbon monoxide detection signal, and wherein in said second operative mode said relay is responsive to the presence of said carbon monoxide detection signal, for not providing said gas valve control signal causing said absence of said gas valve control signal.

9. The system of claim 8, wherein said system further includes an air exhaust device, disposed in said area proximate said combustion appliance and coupled to an area remote from said area proximate said combustion appliance, and responsive to said carbon monoxide detection signal, for moving air from said area proximate said carbon monoxide detector and said combustion appliance to an area remote from said area proximate said carbon monoxide detector and said combustion appliance.

10. The system of claim 9, wherein said area remote from said area proximate said carbon monoxide detector and said combustion appliance includes an area outside of an enclosed building.

11. The system of claim 10, wherein said air exhaust device and said makeup air device are operable in one enclosure including one fan and a plurality of louvers, wherein one of said plurality of louvers is operative in the first mode and in response to said negative air pressure detection signal for providing outside air to said area proximate said combustion appliance, wherein a second one of said plurality of louvers is operative and a second mode in response to said carbon monoxide detection signal, for removing air from said area proximate said combustion appliance to an area remote from said area proximate said combustion appliance.

12. The system of claim 1, wherein said combustion appliance is a heating appliance.

13. The system of claim 12, wherein said heating appliance is selected from the group of heating appliances consisting of a hot water heater and furnace.

14. An air inlet and exhaust device, for controlling inlet and exhaust air to and from an area proximate a combustion appliance, the air inlet and exhaust device comprising:
a combination air exhaust and makeup air device, disposed in one enclosure, said combination air exhaust device and makeup air device including one electrically controllable air fan/blower, disposed in said one enclosure, said combination air exhaust and makeup air device disposed in said one enclosure further including a plurality of air-flow control louvers and one or more air-flow control louver control motors, wherein at least one of said plurality of air-flow control louvers is operative in the first mode and in response to a first electrical signal provided to at least one of said one or more air-flow control louver control motors, for providing an air path from outside air to an area proximate said combustion appliance, wherein at least a second one of said plurality of louvers is operative in a second mode and in response to a second electrical signal provided to at least one of said one or more air-flow control louver control motors, for providing an air path from said area proximate said combustion appliance to an area remote from said area proximate said combustion appliance.

15. The air inlet and exhaust device of claim 14, wherein said air inlet and exhaust device is disposed in said area proximate said combustion appliance and coupled to a source of makeup air, and responsive to a makeup air device activation signal, for selectively providing makeup air to said area proximate said combustion appliance.

16. The an air exhaust device of claim 14, wherein said air inlet and exhaust device is disposed in said area proximate said combustion appliance and coupled to an area remote from said area proximate said combustion appliance, and responsive to an air exhaust control signal, for providing an air path for air from said area proximate said combustion appliance to said area remote from said area, and responsive to said air exhaust control signal, for configuring said at least a second one of said plurality of louvers to be operative in said second mode and for also configuring at least one of said one or more air-flow control louver control motors for providing an air path from said area proximate said combustion appliance to said area remote from said area proximate said combustion appliance.

17. The air exhaust device of claim 16, wherein said air exhaust control signal is a signal from a carbon monoxide detector, and wherein to said area remote from said area proximate said combustion appliance includes an area outside of an enclosed building.
